(19) United States
(12) Patent Application Publication
(10) Pub. No.: US 2016/0297490 A1
(43) Pub. Date: Oct. 13, 2016

(54) Programmable Signal Lighting System for Bicycles

(71) Applicant: Julian Phox Containne, Austin, TX (US)

(72) Inventor: Julian Phox Containne, Austin, TX (US)

(21) Appl. No.: 14/683,150

(22) Filed: Apr. 10, 2015

(51) Int. Cl. B62J 6/00

(52) U.S. Cl. CPC B62J 6/005

(57) ABSTRACT

Bicycle signal light system comprised of tri-color LEDs, visible from front and rear of the bicycle, which can be illuminated in patterns and colors to signal the intent of the cyclist. The signals are actuated by sensors mounted to each brake lever and by a rocker switch. The signal patterns, colors, and intensities can be defined by the operator via an app or computer.

### CROSS-REFERENCE TO RELATED APPLICATIONS

This application is following the submission of provisional patent application Ser. No. 62/082,512 filed on Nov. 20, 2014 under the same title.

### SUMMARY

The present invention is a bicycle signal light system comprised of tri-color LEDS, mounted on a bicycle, visible from front and rear of the bicycle, controlled by a programmable microcontroller, which can illuminate patterns and colors to signal the intent of the cyclist.

The rear-visible LED pattern and color communicates braking intent actuated by a sensor mounted to each brake lever. The front and rear-visible LED pattern and color communicate left or right turning intent, actuated by a 3 position rocker switch, accessible to the rider without requiring the removal of the operator's hand from the handlebars. The signal patterns and colors can be defined by the operator. Mounted near the rear-visible LEDs is a red bicycle reflector.

### BACKGROUND

1. Field of the Invention

This invention relates to communicating a cyclist's intent through use of signal lights.

2. Description of the Related Art

Many commercial LED lighting systems are fixed platforms that include a red intermittent or constant tail light and a forward facing white light for the front of the bicycle. This is the bare minimum as required by law for night riding in most states. There are also some novel implementations U.S. Pat. No. 20140184067, but this style of light does not communicate a cyclist's intent.

A cyclist may communicate his intent through hand signals, which persists only briefly as the rider needs both hands to maintain safe operation of the bicycle. During night riding, hand signals are much less effective due to poor environmental lighting. There are several examples of low cost LED turn signal and braking products which attempt to solve the problem. Many use difficult to reach turn signal switches. Some rely on accelerometers to detect brake triggering. Accelerometers are tricky to calibrate, can trigger false positives, and miss or delay detecting actual braking. An accelerometer coupled with GPS is much more reliable, but significantly more expensive.

### BRIEF DESCRIPTION OF THE DRAWINGS

FIGS. 1a, 1b, and 1c is a three view of the main housing that contains the battery compartment, programmable microcontroller, handlebar mount, and dc to dc converter.

FIG. 2 is a parts view of the main housing containing the battery compartment, programmable microcontroller, handlebar mount, and dc to dc converter.

FIG. 3a, 3b, 3c is a three view of the rear light assembly that consists of the main body, 16 tri-color LED ring, and seat post mount.

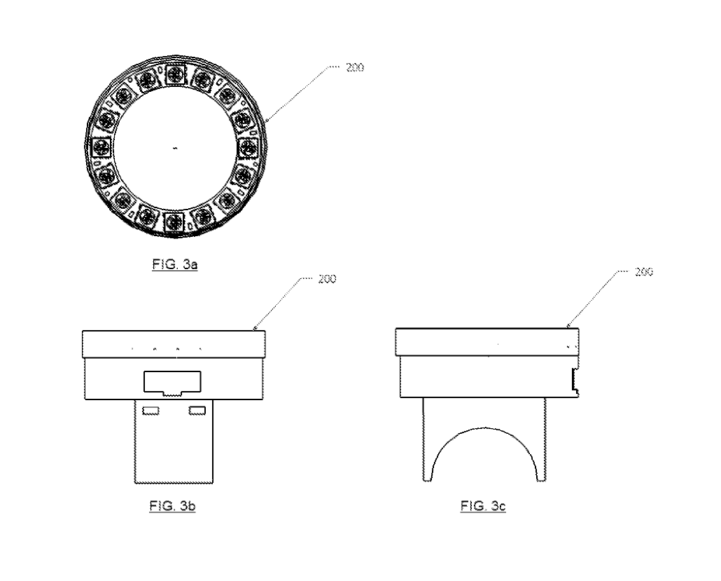

FIG. 4 is a parts view of the rear light assembly that consists of the main body, 16 tri-color LED ring, and seat post mount.

FIG. 5a, 5b, 5c is a three view of the head light structure that consists of the main body, a reed switch, and a tri-color LED.

FIG. 6 is a parts view of the head light structure that consists of the main body, a reed switch, a programmable tri-color LED, and a magnet.

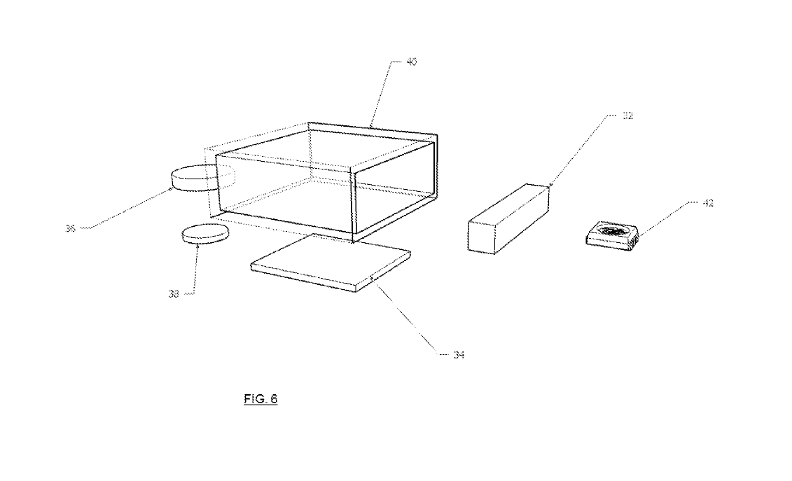

FIG. 7 is a perspective view of a 3 position switch with a generic bicycle handle bar mount.

FIG. 8 is a side view of the bike with the lighting system installed

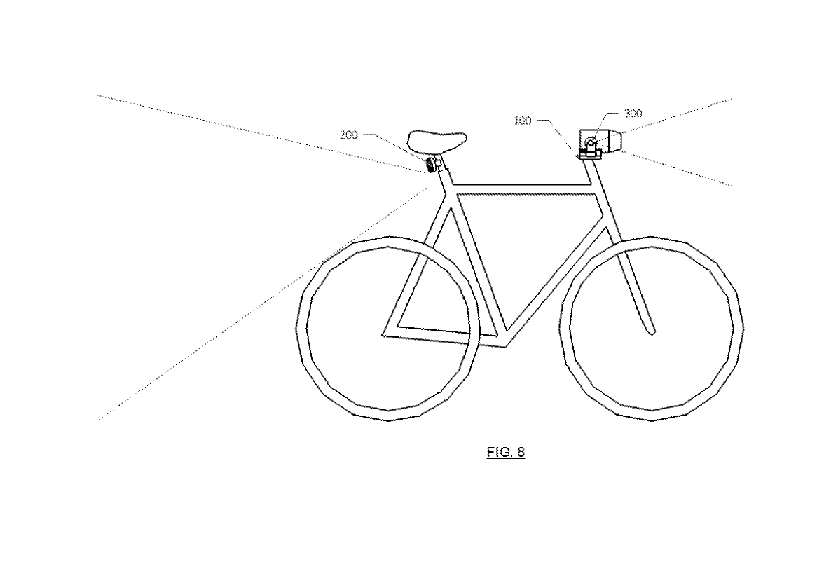

### REFERENCE NUMERALS IN THE DRAWING

10 main housing

12 micro controller

14 DC to DC converter

16 main housing lid

18 handle bar mount

20 momentary push button

22 on/off switch

24 seat post mount

26 rear light housing

28 16 tri-color LED ring

30 rear light housing diffuser

32 reed switch

34 adhesive

36 magnet

38 adhesive for magnet

40 front light housing and diffuser right/left

42 1 tri-color LED

44 handle bar mount

46 switch case

48 three position switch

50 battery compartment AAA×3

100 main control box

200 rear light housing

300 right/left front light cluster

### DETAILED DESCRIPTION

The following description of the preferred embodiments are not the exclusive uses of this invention.

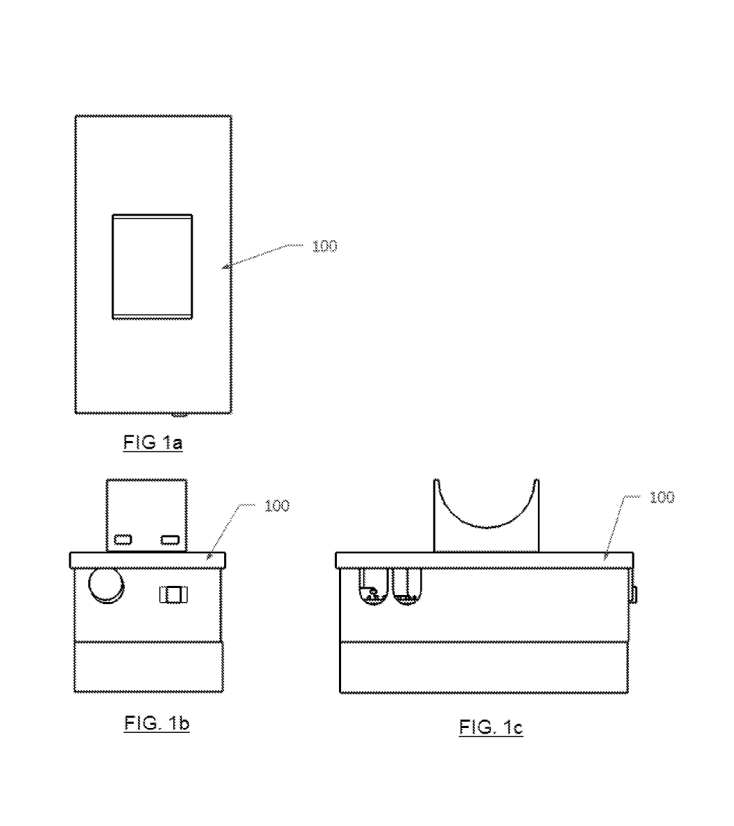

In FIG. 1, the main control box 100 houses the microcontroller whose main function is to drive the tri-color 16 LED ring and forward lighting clusters 300 to display colors and patterns for the purpose of signaling intent while operating a bicycle or similar vehicle. The ring displays color patterns based on programming from the programmable microcontroller unit 16 and the custom software API built on top of the open source programmable microcontroller stack and neopixel library.

The main control box 100 is affixed to the handlebars using a handlebar mount via FIG.

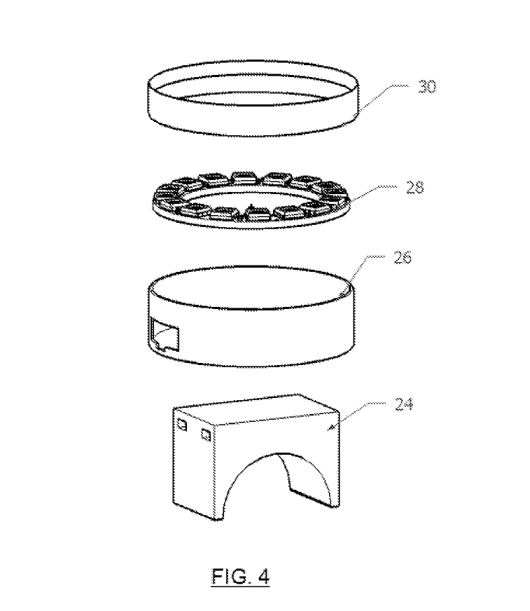

2 18. The rear light housing is affixed to a standard bicycle seat post via FIG. 4 24.

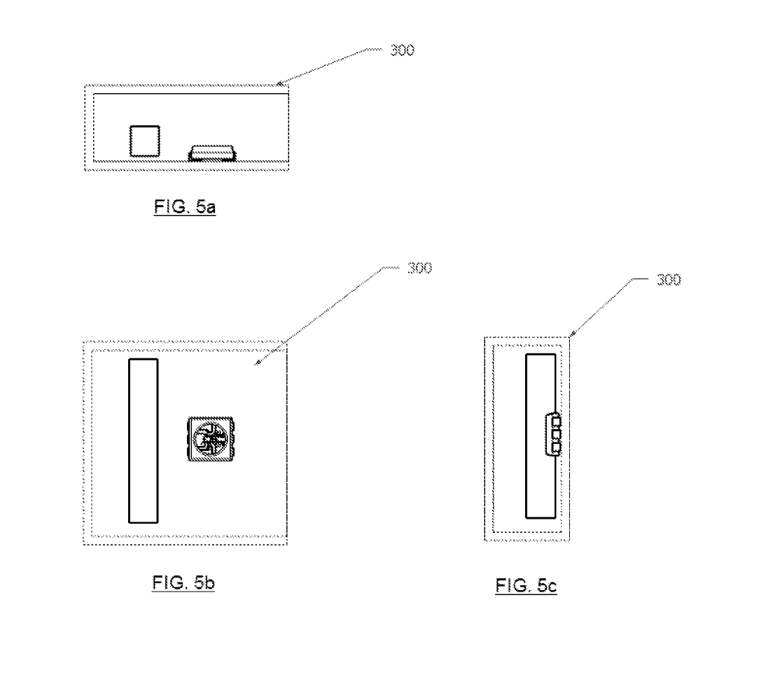

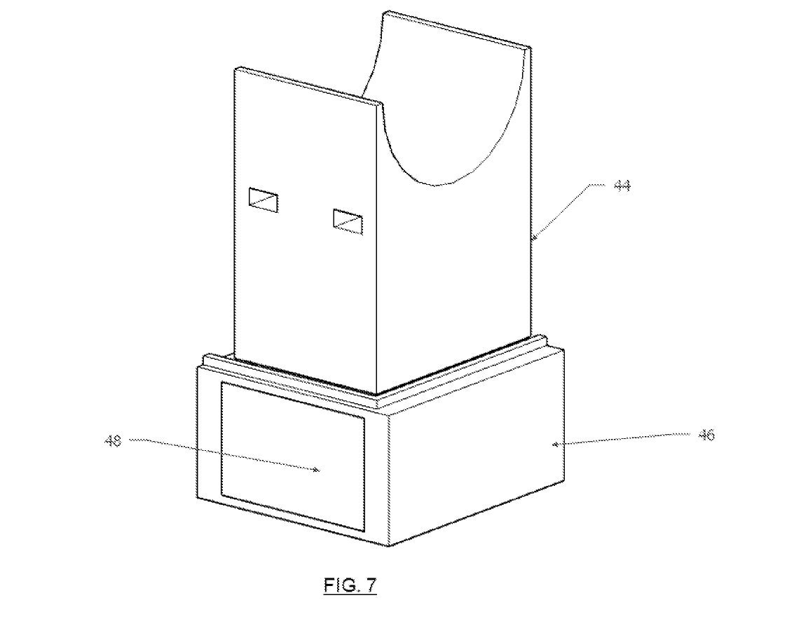

This placement will also allow the optimal visibility when signaling is concerned. The two brake lever mounted lights FIG. 5 300 will be affixed at the actuation point of the brake levers on the handlebars for the left and right brake levers. A neodymium magnet 36 would then be placed next to the front light cluster 300 on the actual brake lever. Actuation of the brake will move the magnet, causing the brake lighting pattern to trigger the default of which entails boosting the intensity of the red running light pattern from the 16 tri-colored LEDs 28 in the rear housing 200. The front light clusters 300 default pattern is white light until triggered by turn signal actuation via the three position switch. The three position switch FIG. 7 40 is mounted to the handlebar of the bicycle and actuating the left/middle/right switch will alternate the colors of the front mounted light clusters 300 and the rear mounted 16 tri-colored LED ring in a pattern indicating intent to turn right or left.

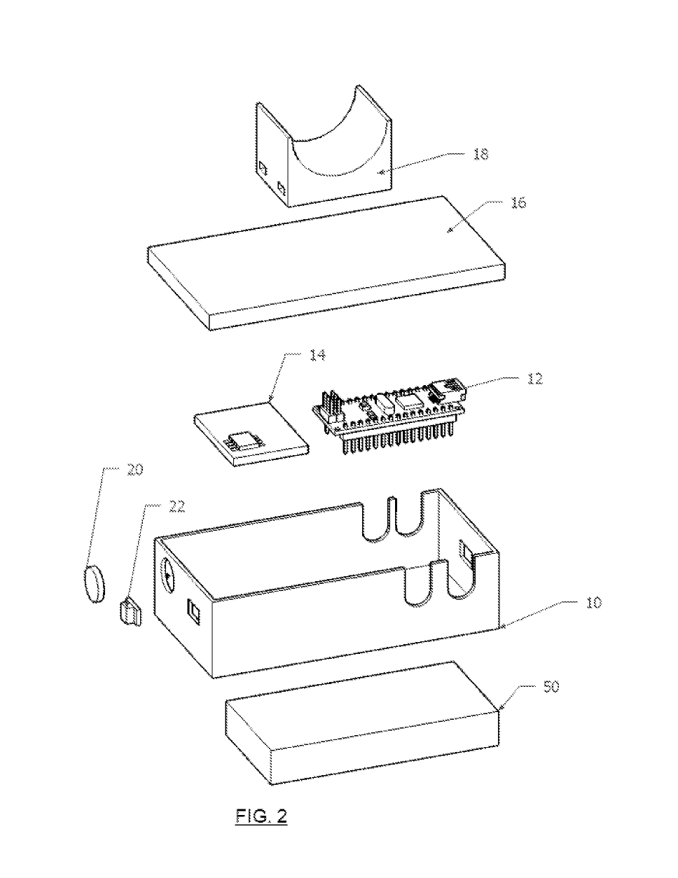

The programmable microcontroller unit 12 allows for the user to connect to the main control box 100 with a standard micro usb cable or wifi depending on the microcontroller used. This connection allows for the programmability of the micro controller. Several profiles are programmable onto the device via an outside software interface which allows for the customization of the signal colors, patterns, and intensity. Users will be able to switch between profiles with a button press FIG. 2 20. Additional sensors may be used in conjunction with lighting schemes to further enhance customizability.

1. Bicycle signal light system comprised of a plurality of tri-color LEDS, mounted on a bicycle, visible from front and rear of the bicycle, controlled by a programmable microcontroller, which can illuminate the LEDs in patterns and colors to signal the intent of the cyclist.

2. The signal light system defined in claim 1, wherein the rear-visible LED pattern and color communicates braking intent actuated by a sensor mounted to each brake lever.

3. The signal light system defined in claim 1, wherein the front and rear-visible LED pattern and color communicates left or right turning intent, actuated by a 3 position rocker switch, accessible to the rider without requiring the removal of the operator's hand from the handlebars.

4. The signal light system defined in claim 1, wherein the signal patterns, colors, and intensity can be defined by the operator.

5. Color profiles as defined by claim 4, shall be savable and sharable with multiple profiles being storable on the device itself to be switched between.

6. The rear 16 LED cluster shall be interchangeable wherein the event of damage or future upgrades.

7. Different micro controllers shall be usable to take advantage of features such as wifi, gps, and motion sensors to further expand capability and convenience
